(19) United States
(12) Patent Application Publication
(10) Pub. No.: US 2015/0042224 A1
(43) Pub. Date: Feb. 12, 2015

(54) Modular Adaptive Headlight

(71) Applicant: Kelsey MacKenzie Stout, Bakersfield, CA (US)

(72) Inventor: Kelsey MacKenzie Stout, Bakersfield, CA (US)

(21) Appl. No.: 14/318,476

(22) Filed: Jun. 27, 2014

Related U.S. Application Data
(60) Provisional application No. 61/840,416, filed on Jun. 27, 2013.

(51) Int. Cl. B60Q 1/04

(52) U.S. Cl. CPC B60Q 1/04
USPC 315/82

(57) ABSTRACT

A modular adaptive vehicle headlight installable in a standard vehicle headlight socket is provided with angled light sources. A control circuit within the headlight controls the light sources to project angled headlight beams to left or right of the vehicle during cornering. The control circuit uses an acceleration sensor which detects accelerative force along the transverse axis of the vehicle. This transverse accelerative force is centrifugal force generated by cornering, allowing the control circuit to determine when cornering is occurring and activate angled light sources to illuminate curves in the road. Thresholds for transverse accelerative force vary with vehicle speed and acceleration. Vertical accelerative force is also detected in order to activate upward and downward angled headlights for dips and rises in the road. Curve illuminating headlighting is thus provided modularly in a headlight, with no need for reference to sensors elsewhere in the vehicle.

### CROSS-REFERENCE TO RELATED APPLICATION

This application claims priority under 35 U.S.C. §119(e) from U.S. Provisional Patent Application No. 61/840,416, by Stout, “Modular Adaptive Headlight”, filed Jun. 27, 2013, which is incorporated by reference for all purposes.

### TECHNICAL FIELD

The present invention relates generally to vehicle headlamps. More particularly, the present invention relates to a modular adaptive vehicle headlight.

### BACKGROUND INFORMATION

Many systems exist for causing vehicle headlights to follow road turnings. However, these systems tend to use complex arrangements of cameras, motors, mechanical sensors and wiring distributed throughout the vehicle. The complexity of such systems makes for prohibitive expense in installation, repair and replacement. A simplified, robust and modular adaptive vehicle headlight is sought.

### SUMMARY

A vehicle headlight system comprises a front-facing light, a leftward-angled light and a rightward angled light. The headlight system also comprises an accelerometer situated to measure transverse accelerative force. When the accelerometer detects leftward centrifugal force due to a rightward turn by the vehicle, the rightward-angled light is lit, illuminating the rightward path of the vehicle. When the accelerometer detects rightward centrifugal force due to a leftward turn by the vehicle, the leftward-angled light is lit, illuminating the leftward path of the vehicle.

The accelerometer may also detect acceleration along a second axis, and may detect acceleration along a third axis. Where the accelerometer is situated to detect vertical accelerative force, the headlight system also comprises an upward-angled light and a downward-angled light. When the accelerometer detects upward centrifugal force due to cresting a hill by the vehicle, the downward-angled light is lit, illuminating the downhill path of the vehicle. When the accelerometer detects downward centrifugal force due to the vehicle entering the start of a rise, the upward-angled light is lit, illuminating the uphill path of the vehicle.

The forward-facing light typically remains active. High-beams or low-beams are projected as in a standard headlight. Color temperature of the lights may be varied depending on whether the light source is illuminating the shoulder or the axis of the road.

Where the accelerometer is situated to detect lengthwise accelerative force, the headlight system may alter responses of the headlight system based on the speed of the vehicle. For example, the sensitivity of the headlight system to transverse acceleration may be lowered at high speeds to ignore momentary course corrections. The sensitivity at low speeds may be increased to account for lowered centrifugal force during low-speed turning. Momentary vertical shocks may be filtered out in order to ignore rough roads. Roadside-facing beam characteristics, such as lowered beams or lowered color temperature, may be applied to lights which are determined to be facing the roadside.

The headlight system typically comprises two light housings, each containing an accelerometer and each installable in a vehicle by connecting to a standard headlight socket.

Other methods and structures are described in the detailed description below. This summary does not purport to define the invention. The invention is defined by the claims.

### BRIEF DESCRIPTION OF THE DRAWINGS

FIG. 1 is a simplified view from above of a single modular adaptive headlight, showing three light facings in one headlight and a control circuit in accordance with an embodiment of the invention.

FIG. 2 is a view from above view of a vehicle showing the operation of a modular adaptive headlight installed in the left headlight socket.

FIG. 3 is a view from above of a vehicle showing the operation of a modular adaptive headlight installed in the right headlight socket.

FIG. 4 is a simplified view from the side of a single modular adaptive headlight, showing three light facings in one headlight and a control circuit in accordance with an embodiment of the invention.

FIG. 5 is a side view of a vehicle cresting a hill, showing the operation of a modular adaptive headlight according to one embodiment of the invention.

FIG. 6 is a side view of a vehicle reaching the bottom of a hill, showing the operation of a modular adaptive headlight according to one embodiment of the invention.

FIG. 7 is a more detailed view from above of a control circuit of a modular adaptive headlight, in accordance with an embodiment of the invention in which the modular adaptive headlight adapts the facing of high-beams in a vehicle negotiating a turn.

### DETAILED DESCRIPTION

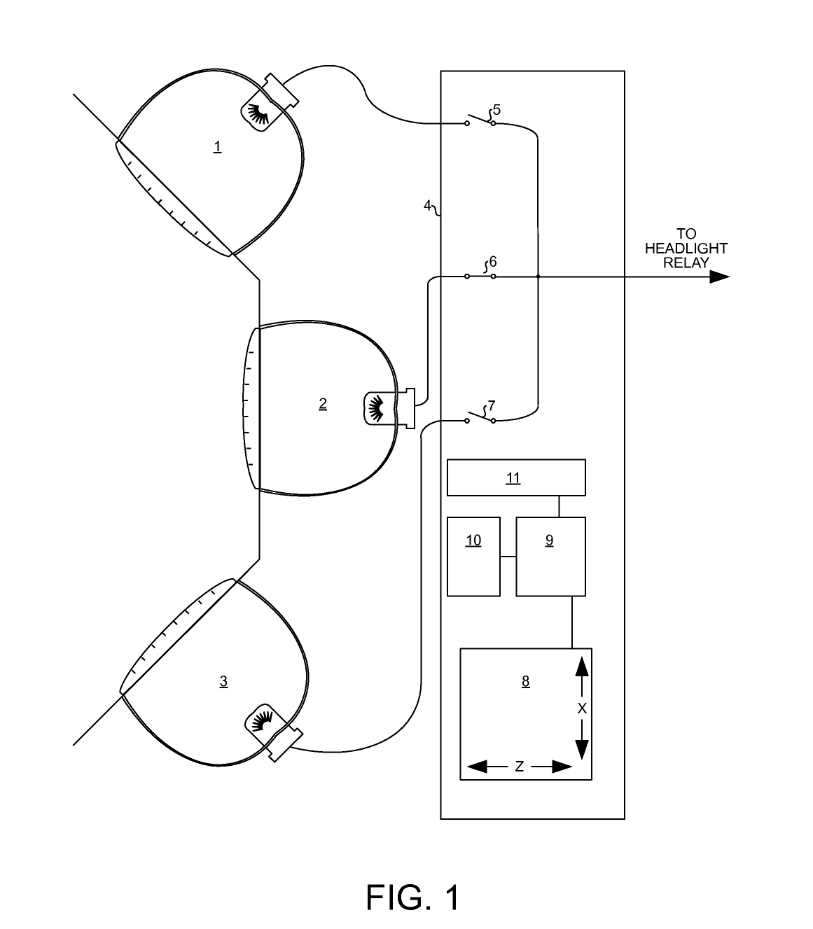

FIG. 1 is a simplified view from above of a modular adaptive headlight, showing light facings and control circuit in accordance with an embodiment of the invention. The modular adaptive headlight is disposed such that there is a leftward-angled light source 1, a front-facing light source 2 and a rightward-angled light source 3. Each light source comprises one or more lamps of types known in the art, such as lamps and LEDs. Light sources are capable of typical headlight functions, such as high-beam, low-beam and varying light color temperature, as necessary.

Each of leftward-angled light source 1, forward-facing light source 2 and rightward-angled light source 3 are controllable by a control circuit 4 to switch on and off, via switches 6, 7 and 8. In the preferred embodiment, the forward-facing light source 2 remains on throughout the operation of the headlights. The leftward-angled light source 1 and rightward-angled light source 3, however, are switched off or on in response to accelerative forces as detected by the accelerometer 8.

Two axes of acceleration measurable by the accelerometer are indicated on the drawing of the accelerometer as the X axis and the Z axis. The modular adaptive headlight is installed in the vehicle such that the X axis of the accelerometer 8 is transverse to the vehicle and the Z axis is lengthwise to the vehicle. Thus, accelerative force leftward or rightward as measured by the accelerometer 8 is said to be along the X axis. Accelerative force toward the front or toward the rear of the vehicle as measured by the accelerometer 8 is said to be along the Z axis. The accelerometer may also measure upward and downward acceleration along a Y axis in some embodiments.

Accelerative force along the X axis, as centrifugal force, indicates that the vehicle is cornering. The processor 9 receives accelerative force data from the accelerometer 8, typically in the form of an output voltage, and activates the leftward-angled light source 1 or rightward-angled light source 3 in response. In one embodiment, the accelerometer 8 measures accelerative force only along the X axis, and activates one of leftward-angled light source 1 and rightward-angled light source 3 when the acceleration along the X axis exceeds a threshold level, by means of a multiplexer 11. This threshold level may be stored in onboard memory of the processor, or may be stored in a separate memory 10. Where the accelerometer 8 detects acceleration toward the left of the vehicle, the rightward-angled light source 3 is activated; where the accelerometer 8 detects acceleration toward the right of the vehicle, the leftward-angled light source 1 is activated.

In another embodiment, the accelerometer 8 measures accelerative force along both the X axis and the Z axis. Acceleration measured along the Z axis is used by the processor to determine the vehicle's acceleration and, via inertial measurement, current velocity. In this embodiment, the processor constructs a ratio of vehicle velocity in the Z direction to acceleration in the X direction and compares this ratio to a threshold, activating one of leftward-angled light source 1 and rightward-angled light source 3 if the threshold is exceeded. A high rate of speed in the Z direction will, in this embodiment, require a higher rate of acceleration in the X direction to meet the threshold for activating one of leftward-angled light source 1 and rightward-angled light source 3. In a variation, a comparison of acceleration in the Z direction to acceleration in the X direction may also be used as part of the criteria for activating one of leftward-angled light source 1 and rightward-angled light source 3.

In another embodiment, the processor 9 takes into account whether the front-facing light source 2 has been set by the vehicle driver to produce a high-beam or a low-beam. In this case, the activated one of leftward-angled light source 1 and rightward-angled light source 3 is set to produce the same high-beam or a low-beam as the front-facing light source 2. Further, in another embodiment, where the driver has turned on high-beams, the activated one of leftward-angled light source 1 and rightward-angled light source 3 produces the high-beam, and the front-facing light source 2 produces a low-beam so long as the vehicle is cornering and the activated one of leftward-angled light source 1 and rightward-angled light source 3 is active.

Other advantages can be applied that distinguish between the shoulder and axis of the road. For instance, where a light source is illuminating the shoulder of a road, it can be advantageous to use blueish light to illuminate objects. On the other hand, where a light source is illuminating the axis of the road, it can be advantageous to use a more yellow or orange tinged light to avoid blinding on-coming traffic. In one embodiment of the invention, the activated leftward-angled light source 1 or rightward-angled light source 3 during a turn uses a yellow or orange tinged beam of light to illuminate the axis of the road, and the front-facing light source 2 uses a blue tinged beam of light to illuminate the road shoulder. When not cornering, the activated front-facing light source uses an orange or yellow tinged beam of light to illuminate the axis of the road.

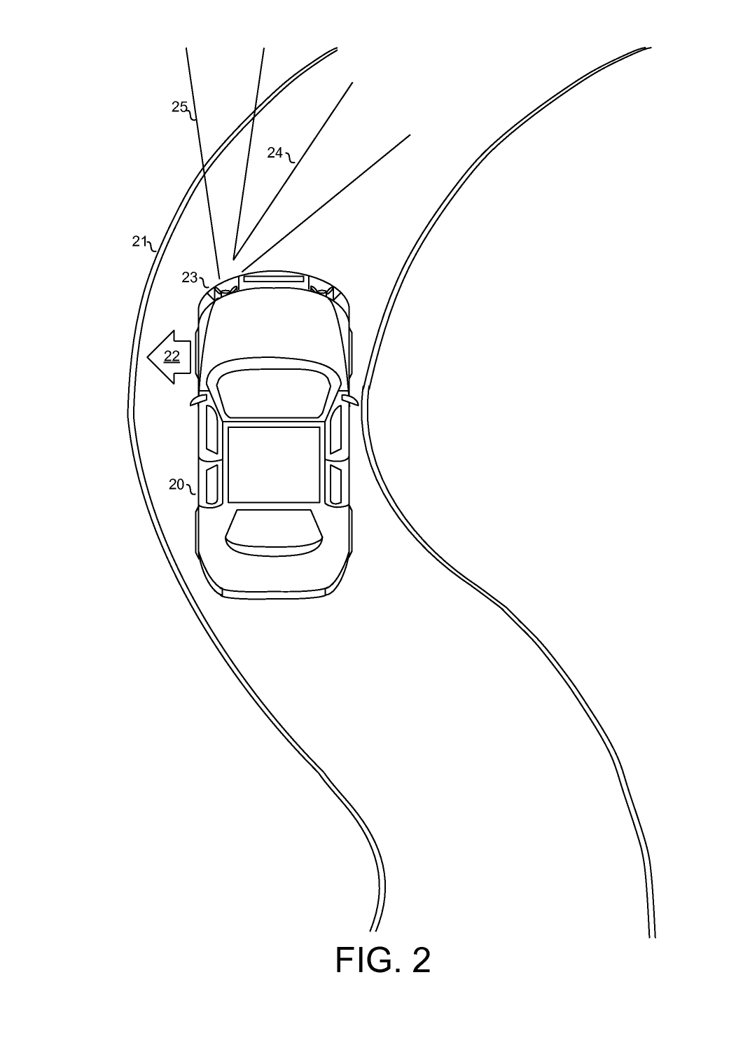

FIG. 2 is view from above view of a vehicle showing the operation of a modular adaptive headlight 23 installed in the left headlight socket. Vehicle 20 is negotiating a rightward curve in a road 21. An arrow 22 indicates the centrifugal force generated by the cornering of the vehicle.

A modular adaptive headlight 23 is installed in the left headlight socket of the vehicle 20. The centrifugal force indicated by the arrow 22 is transverse to the vehicle and, thus, measured as accelerative force along the X axis of the accelerometer of the indicated modular adaptive headlight 23, according the description of FIG. 1, above.

Because the modular adaptive headlight 23 is detecting leftward centrifugal force, the rightward-angled light source of the modular adaptive headlight 23 is activated, producing a rightward-angled beam of light 24 that illuminates the rightward curve of the road 21. The forward-facing light source of the modular adaptive headlight 23 also remains activated throughout the turn, producing a forward-facing beam of light 25 that illuminates the shoulder of the road 21.

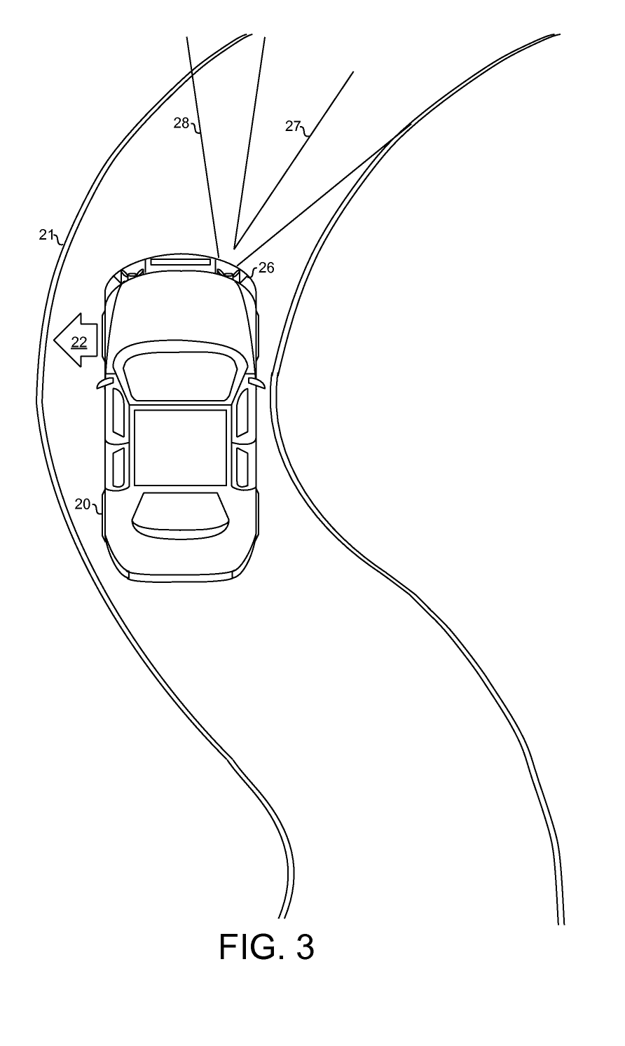

FIG. 3 is a second view from above of a vehicle showing the operation of a second modular adaptive headlight 26, installed in the right headlight socket. Vehicle 20 is negotiating the same rightward curve as in FIG. 2, above.

Because the second modular adaptive headlight 26 is detecting the leftward centrifugal force indicated by the arrow 22, the rightward-angled light source of the modular adaptive headlight 26 is activated, producing a rightward-angled beam of light 27 that illuminates the rightward curve of the road 21. The forward-facing light source of the modular adaptive headlight 26 also remains activated throughout the turn, producing a forward-facing beam of light 28 that illuminates the shoulder of the road 21.

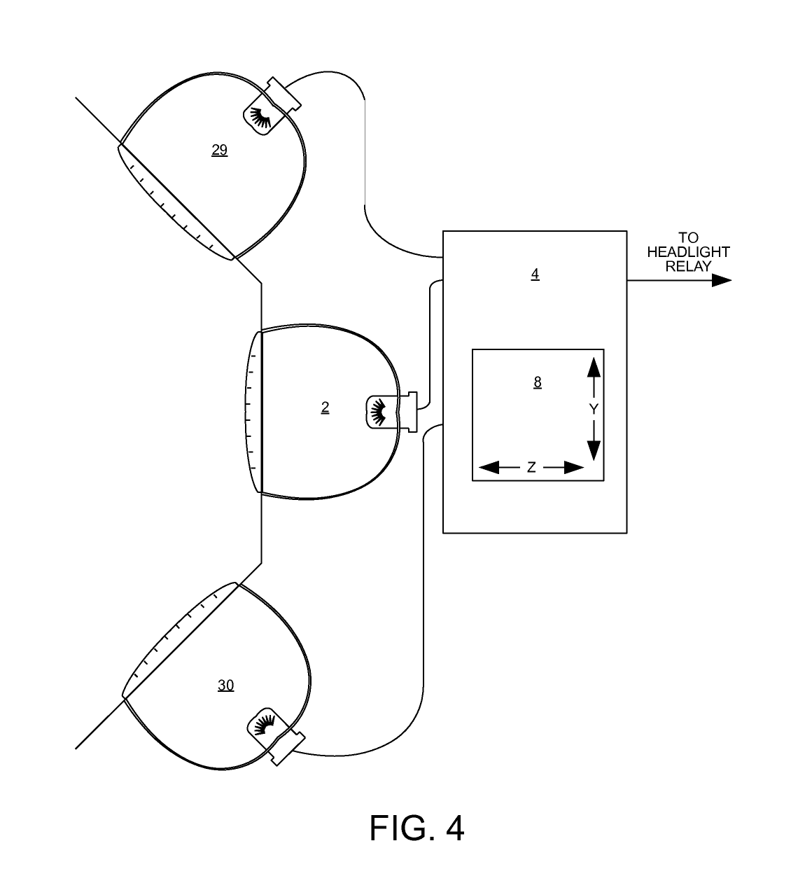

FIG. 4 is a simplified view from the side of a modular adaptive headlight, showing light facings and control circuit in accordance with an embodiment of the invention. The modular adaptive headlight is disposed such that there is a downward-angled light source 29, the front-facing light source 2, as found in the description of FIG. 1, above, and an upward-angled light source 30. Each light source comprises one or more lamps of types known in the art, such as incandescent lamps and LEDs. Light sources are capable of typical headlight functions, such as high-beam, low-beam and varying light color temperature, as necessary.

Each of downward-angled light source 29, front-facing light source 2 and upward-angled light source 30 are controllable by the control circuit 4 to switch on and off. In the preferred embodiment, the front-facing light source 2 remains on throughout the operation of the headlights. The downward-angled light source 29 and upward-angled light source 30, however, are switched off or on in response to accelerative forces as detected by the accelerometer 8.

Two axes of acceleration measurable by the accelerometer are indicated on the drawing of the accelerometer 8 as the Y axis and the Z axis. The modular adaptive headlight is installed in the vehicle such that the Y axis of the accelerometer 8 points upward and downward in a vehicle on a flat surface. As is explained above, in regard to FIG. 1, the Z axis is lengthwise to the vehicle. Accelerative force upward or downward as measured by the accelerometer 8 is said to be along the Y axis. Accelerative force toward the front or toward the rear of the vehicle as measured by the accelerometer 8 is said to be along the Z axis.

Centrifugal force along the Y axis indicates that the vehicle is encountering the inflection of a slope in the road. When the accelerometer 8 detects centrifugal force along the Y axis, the control circuit 4 activates one of the downward-facing light source 29 and upward-facing light source 30 in response. In one embodiment, the accelerometer 8 measures accelerative force only along the Y axis, and activates one of downward-facing light source 29 and upward-facing light source 30 when the acceleration along the Y axis exceeds a threshold level. This threshold level may be stored in onboard memory of a processor (shown in FIG. 1), or may be stored in a separate memory (shown in FIG. 1). Where the accelerometer 8 detects acceleration toward the top of the modular adaptive headlight, the downward-facing light source 29 is activated; where the accelerometer 8 detects acceleration toward the bottom of the modular adaptive headlight, the upward-facing light source 30 is activated.

In another embodiment, the accelerometer 8 measures accelerative force along both the Y axis and the Z axis. Acceleration measured along the Z axis is used by the processor to determine the vehicle's acceleration and, via inertial measurement, current velocity. In this embodiment, the processor constructs a ratio of vehicle velocity in the Z direction to acceleration in the Y direction and compares this ratio to a threshold, activating one of downward-facing light source 29 and upward-facing light source 30 if the threshold is exceeded. A high rate of speed in the Z direction will, in this embodiment, require a higher rate of acceleration in the Y direction to meet the threshold for activating one of downward-facing light source 29 and upward-facing light source 30. In a variation, a comparison of acceleration in the Z direction to acceleration in the Y direction may also be used as part of the criteria for activating one of leftward-angled light source 1 and rightward-angled light source 3. Additionally, road bumps and potholes may be filtered out by ignoring extremely sharp accelerations along the Y axis that occur over extremely short periods of time, such as under one second.

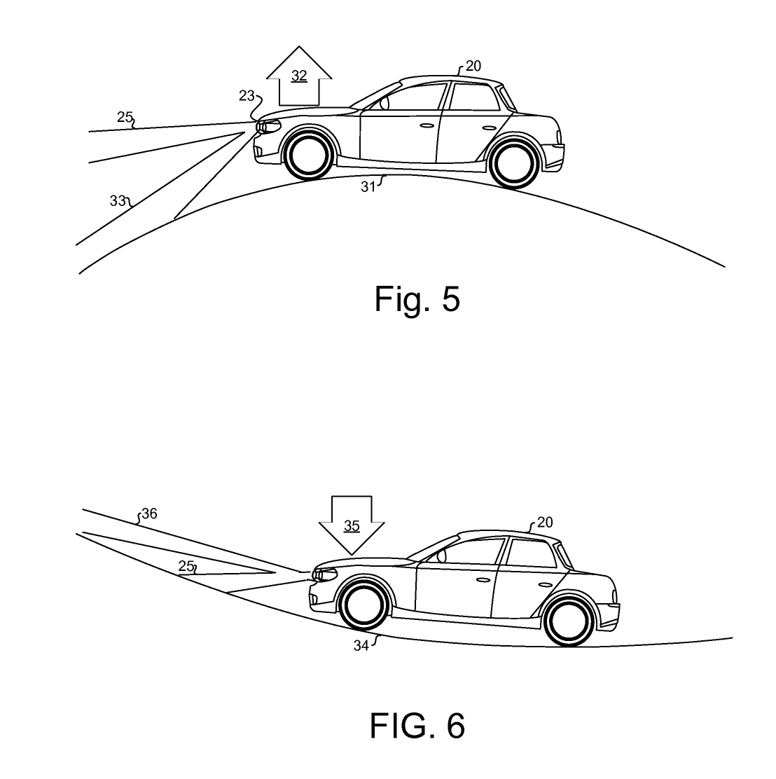

FIG. 5 is a side view of a vehicle 20 cresting a hill 31, showing the operation of a modular adaptive headlight according to one embodiment. An arrow 32 indicates the centrifugal force generated by the cornering of the vehicle.

A modular adaptive headlight 23 is installed in the left headlight socket of the vehicle 20. The centrifugal force indicated by the arrow 32 is upward and, thus, measured as accelerative force along the Y axis of the accelerometer of the indicated modular adaptive headlight 23, according the description of FIG. 1I, above.

Because the modular adaptive headlight 23 is detecting upward centrifugal force, the downward-angled light source of the modular adaptive headlight 23 is activated, producing a downward-angled beam of light 33 that illuminates the downward slope of the road 31. The forward-facing light source of the modular adaptive headlight 23 also remains activated throughout the inflection, producing a forward-facing beam of light 24 as in a typical headlight.

FIG. 6 is a side view of a vehicle reaching the bottom of a hill, showing the operation of a modular adaptive headlight according to one embodiment. A modular adaptive headlight 23 is installed in a headlight socket of the vehicle 20.

The centrifugal force indicated by the arrow 35 is downward and, thus, measured as accelerative force along the Y axis of the accelerometer of the indicated modular adaptive headlight 23, according the description of FIG. 4, above.

Because the modular adaptive headlight 23 is detecting downward centrifugal force, the upward-angled light source of the modular adaptive headlight 23 is activated, producing an upward-angled beam of light 36 that illuminates the downward slope of the road 34. The forward-facing light source of the modular adaptive headlight 23 also remains activated throughout the inflection, producing a forward-facing beam of light 25 as in a typical headlight.

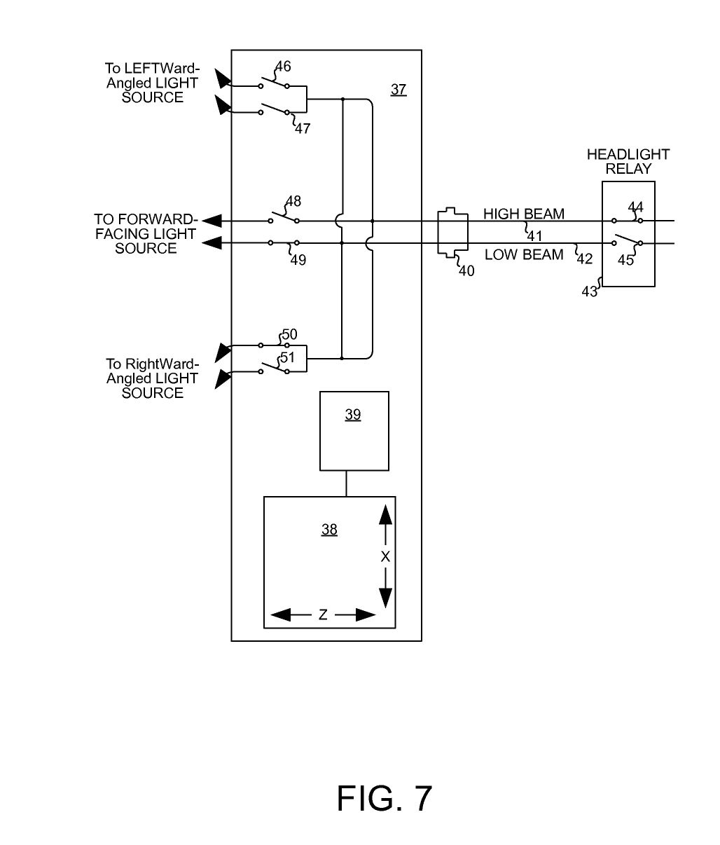

FIG. 7 is a more detailed view from above of a control circuit 37 of a modular adaptive headlight, in accordance with an embodiment of the invention in which the modular adaptive headlight adapts the facing of high-beams in a vehicle negotiating a turn. The control circuit 37 is part of a modular adaptive headlight installed in a vehicle negotiating a rightward curve, as is shown in FIG. 2.

The modular adaptive headlight is plugged into a typical vehicle headlight socket via a connector 40. The connector 40 admits a high-beam wire 41 and a low-beam wire 42 from the vehicle's headlight relay 43. No non-standard wires are required to enter the modular adaptive headlight via the connector 40. Vehicle high-beam switch 44 and vehicle low-beam switch 45 are indicated in the vehicle headlight relay 43. In the indicated example, the vehicle headlight relay has high-beams activated and low-beams inactive.

The control circuit 37 is arranged such that the high-beam or low-beam of any of front-facing light source or angled light source can be activated if either high-beam or low-beam is activated at the vehicle headlight relay 43. In the illustrated embodiment, any of leftward-angled high-beam switch 46, leftward-angled low-beam switch 47, front-facing high-beam switch 48, front-facing low-beam switch 49, rightward-angled high-beam switch 50 or rightward-angled low-beam switch 51 can be closed to activate an associated light source if either of high-beams or low-beams are activated via the vehicle headlight relay 43.

In the illustrated example, high-beams are activated via vehicle high-beam switch 44. The accelerometer 38 and processor 39 detect leftward centrifugal force and determine that the vehicle is negotiating a rightward curve. Therefore, control circuit 37 activates rightward-angled high-beams via rightward-angled high-beam switch 50 such that the direction of travel is illuminated by high-beams. Further, because the front-facing lights are now pointed at the shoulder of the road, control circuit 37 closes forward-facing low-beam switch 49 and opens forward-facing high-beam switch 48 such that forward-facing low-beams illuminate the road shoulder.

Note that the depicted shape of any aspect of the modular adaptive headlight is not the only possible shape. In some embodiments, a left modular adaptive headlight may have only one side-angled light source, leaving the opposite side-angled light source to be provided by the right modular adaptive headlight. The indicated control circuit may be implemented in analog fashion, activating the appropriate light sources in response to outputs from an analog accelerometer. Embodiments may use angled light sources at various angles, such as two or more different left, right, up or down angles.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A vehicle headlight assembly, comprising:
a front-facing light;
a first leftward-angled light source;
a first rightward-angled light source;
an accelerometer configured to detect acceleration along the transverse axis of a vehicle into which the headlight is installed; and
a control circuit configured to activate one of said left-ward angled light source or said rightward-angled light source in response to the detecting of said transverse acceleration by said accelerometer.

2. The vehicle headlight of claim 1, also comprising:
a vehicle headlight socket connector.

3. The vehicle headlight of claim 1, also comprising:
an upward-angled light source; and
a downward-angled light source, wherein said accelerometer is configured to detect acceleration along the vertical axis of a vehicle into which the headlight is installed, wherein said control circuit is configured to activate one of said upward-angled light source or said downward-angled light source in response to the detecting of said vertical acceleration by said accelerometer.

4. The vehicle headlight of claim 1, wherein said control circuit is configured to activate one of said left-ward angled light source or said rightward-angled light source if the amount of transverse acceleration detected by said accelerometer exceeds a first threshold.

5. The vehicle headlight of claim 4, wherein said accelerometer is configured to detect forward acceleration and deceleration of a vehicle into which the headlight is installed, wherein said control circuit is configured to estimate the speed of a vehicle into which the headlight is installed using said detection of forward acceleration and deceleration, and wherein said threshold varies based on said estimated speed.

6. The vehicle headlight of claim 1, further comprising:
a second leftward-angled light source which faces at a different leftward angle from said first leftward-angled light source, said first light source being activated; and
a second rightward-angled light source which faces at a different rightward angle from said first rightward-angled light source.

7. The vehicle headlight of claim 1, wherein said front-facing light source is capable of producing a high-beam and a low-beam, wherein a front-facing light source that is producing a high-beam switches to a low-beam upon activation of a leftward-angled light source or a rightward-angled light source.

8. The vehicle headlight of claim 7, wherein said control circuit is configured to activate one of said left-ward angled light source or said rightward-angled light source if the amount of transverse acceleration detected by said accelerometer exceeds a first threshold, and wherein said control circuit is configured to switch a front-facing light source that is producing a high-beam to a low-beam if the amount of transverse acceleration detected by said accelerometer exceeds a second threshold

9. The vehicle headlight of claim 1, wherein said front-facing light source is capable of producing a warm-colored beam and a cool-colored beam, wherein said front-facing light source produces a cool-colored beam when a leftward-angled light source or a rightward-angled light source is active and wherein said front-facing light source produces a warm-colored beam when a leftward-angled light source or a rightward-angled light source is not active.

10. The vehicle headlight of claim 9, wherein said control circuit is configured to activate one of said left-ward angled light source or said rightward-angled light source if the amount of transverse acceleration detected by said accelerometer exceeds a first threshold, and wherein said control circuit is configured to switch a front-facing light source from producing a warm-colored beam to producing a cool-colored beam if the amount of transverse acceleration detected by said accelerometer exceeds a second threshold.

11. The vehicle headlight of claim 1, wherein said accelerometer is configured to detect forward acceleration and deceleration of a vehicle into which the headlight is installed, wherein said control circuit is configured to estimate the speed of a vehicle into which the headlight is installed using said detection of forward acceleration and deceleration, and wherein said control circuit is configured to calculate at least one threshold of transverse or vertical acceleration based on said estimated speed.

12. The vehicle headlight of claim 1, wherein said control circuit is configured to ignore extremely sharp vertical accelerations associated with bumps or potholes.

13. The vehicle headlight of claim 1, said vehicle headlight being functional when installed in a standard vehicle headlight socket.

14. The vehicle headlight of claim 1, said vehicle headlight requiring no control wires from the vehicle into which it is installed.

15. A headlight system, comprising:
a left headlight, comprising the vehicle headlight of claim 1; and
a right headlight, comprising the vehicle headlight of claim 1.

16. The headlight system of claim 15, wherein said left headlight does not comprise a leftward-angled light source and wherein said right headlight does not comprise a rightward-angled light source.

17. The headlight system of claim 15, wherein said left headlight does not comprise a rightward-angled light source and wherein said right headlight does not comprise a leftward-angled light source.
